(19) United States
(12) Patent Application Publication
(10) Pub. No.: US 2020/0213687 A1
(43) Pub. Date: Jul. 2, 2020

(54) SENSOR SYSTEM

(71) Applicant: DENSO CORPORATION, Kariya-city (JP)

(72) Inventor: Takuya NOMURA, Kariya-city (JP)

(21) Appl. No.: 16/816,563

(22) Filed: Mar. 12, 2020

Related U.S. Application Data
(63) Continuation of application No. PCT/JP2018/032237, filed on Aug. 30, 2018.

(30) Foreign Application Priority Data
Sep. 15, 2017 (JP) 2017-178158

(51) Int. Cl. H04Q 9/02; H04L 29/08; H04J 3/00

(52) U.S. Cl. CPC H04Q 9/02; H04L 67/12; H04Q 2209/30; H04Q 2209/826; H04Q 2209/10; H04J 3/00

(57) ABSTRACT

A sensor system includes at least one sensor and a control unit. The at least one sensor and the control unit communicate with each other using a time-division multiplexing method. The control unit is capable of being connected to a plurality of sensors that configures the at least one sensor, and transmits a data transmission command to the at least one sensor connected to the control unit at every fixed amount of time. In response to the number of at least one target sensor, among the at least one sensor, for transmitting data collected by the control unit being less than the number of time slots allocated within the fixed amount of time, the at least one sensor transmits data to the control unit using a plurality of time slots.

### CROSS-REFERENCE TO RELATED APPLICATIONS

The present application is a continuation application of International Application No. PCT/JP2018/032237, filed Aug. 30, 2018, which claims priority to Japanese Patent Application No. 2017-178158, filed Sep. 15, 2017. The contents of these applications are incorporated herein by reference in their entirety.

### BACKGROUND

### Technical Field

The present disclosure relates to a sensor system that performs communication using a time-division multiplexing method.

### Related Art

In an object detection apparatus or the like that is mounted to a vehicle, a periodic data collection mode (PDCM) is used for data communication between an electronic control unit (ECU) and a plurality of sensors that are connected to the ECU. PDCM is a type of data collection method in Distributed System Interface 3 (DSI3) communication.

### SUMMARY

An aspect of the present disclosure provides a sensor system that includes at least one sensor and a control unit. The at least one sensor and the control unit communicate with each other using a time-division multiplexing method. The control unit is configured to be capable of being connected to a plurality of sensors configuring the at least one sensor, and transmits a data transmission command to the at least one sensor connected to the control unit at every fixed amount of time. In response to the number of at least one target sensor, among the at least one sensor, for transmitting data collected by the control unit being less than the number of time slots allocated within the fixed amount of time, the at least one sensor transmits data to the control unit using a plurality of time slots.

### BRIEF DESCRIPTION OF THE DRAWINGS

In the accompanying drawings:

FIG. 1 is a diagram of a configuration of a sensor system according to a first embodiment;

FIG. 2 is a diagram of operations of the sensor system according to the first embodiment;

FIG. 3 is a diagram of operations of a conventional sensor system;

FIG. 4 is a diagram of a configuration of a sensor system according to a second embodiment;

FIG. 5 is a diagram of operations of a sensor system according to another embodiment;

FIG. 6 is a diagram of operations of a sensor system according to another embodiment;

FIG. 7 is a diagram of operations of a sensor system according to another embodiment; and

FIG. 8 is a diagram of operations of a sensor system according to another embodiment.

### DESCRIPTION OF THE EMBODIMENTS

In PDCM, the ECU, serving as a master, transmits a synchronous signal at a fixed interval. Then, when each sensor, serving as a slave, receives the synchronous signal from the ECU, the sensor transmits data to the ECU. A timing at which the data is transmitted after reception of the synchronous signal differs with each sensor. Data is successively transmitted to the ECU from the sensors.

The interval at which the ECU transmits the synchronous signal and the number of time slots that are allocated within the interval are prescribed taking into consideration the maximum number of sensors that are connected to the ECU. Thus, when the number of target sensors used for transmitting data that is collected by the ECU is less than the maximum number of sensors connected to the ECU, a proportion of time used for data transmission from each sensor within the transmission interval of the synchronous signal becomes small. Therefore, idle time increases and communication efficiency decreases.

In this regard, for example, JP-A-2012-204863 proposes a method for actively changing a length of a single time slot, thereby improving communication efficiency.

However, in the method in which the length of the time slot is changed as described in JP-A-2012-204863, the master is required to have a function for ascertaining the length of each time slot. Therefore, system configuration becomes complex, thereby leading to increase in cost.

It is thus desired to provide a sensor system that is capable of improving communication efficiency by a simple configuration.

An exemplary embodiment of the present disclosure provides a sensor system that includes at least one sensor and a control unit. The at least one sensor and the control unit communicate with each other using a time-division multiplexing method. The control unit is configured to be capable of being connected to a plurality of sensors configuring the at least one sensor, and transmits a data transmission command to the at least one sensor connected to the control unit at every fixed amount of time. In response to the number of at least one target sensor, among the at least one sensor, for transmitting data collected by the control unit being less than the number of time slots allocated within the fixed amount of time, the at least one sensor transmits data to the control unit using a plurality of time slots using a plurality of transmission identifiers that predetermine a timing at which each of the plurality of sensors transmits data.

As a result of a single sensor transmitting data using a plurality of time slots in this manner, communication density can be increased without length of the time slot being changed. Consequently, communication efficiency can be improved by a simple configuration.

Embodiments of the present disclosure will hereinafter be described with reference to the drawings. Here, sections that are identical or equivalent to each other among the embodiments below are described using the same reference numbers.

### First Embodiment

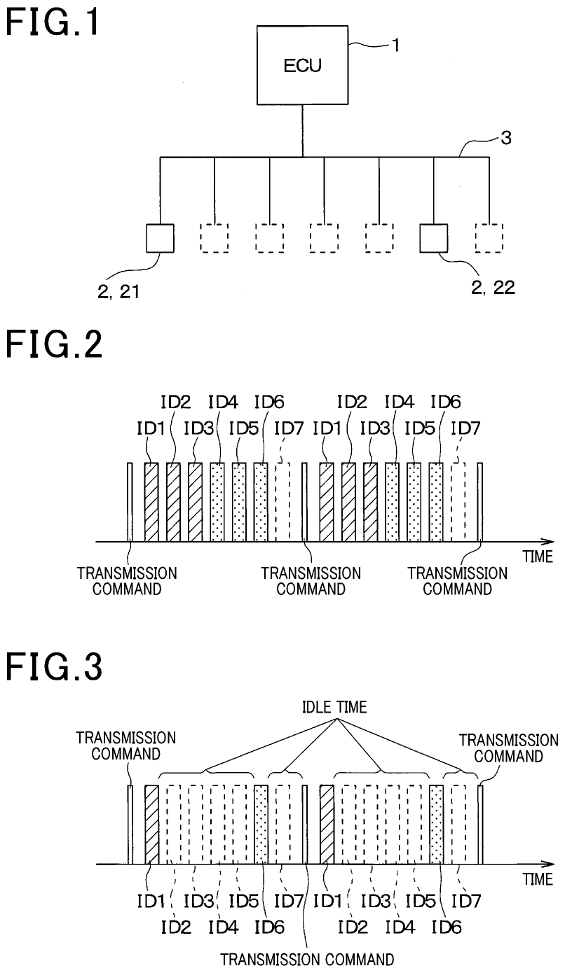

A first embodiment will be described. Here, an example in which a sensor system is applied to an object detection apparatus that is mounted in a vehicle will be described. As shown in FIG. 1, the sensor system according to the present embodiment includes an ECU 1 and a sensor 2. The ECU 1 serves as a control unit.

The sensor 2 is an ultrasonic sensor that measures a distance to an object outside the vehicle using ultrasonic waves. The sensor 2 is connected by wired connection to the ECU 1 by wiring 3. The sensor 2 transmits the ultrasonic waves outside the vehicle based on a wave transmission command from the ECU 1. The sensor 2 receives reflected waves and measures the distance to the object. Then, the sensor 2 transmits data on the measured distance to the ECU 1 based on a data transmission command from the ECU 1.

The ECU 1 is configured such that a plurality of sensors 2 can be connected thereto. The ECU 1 and the sensors 2 are configured to communicate using a time-division multiplexing method. The ECU 1 outputs the data transmission command to the connected sensors 2 at every fixed amount of time. The data transmission command from the ECU 1 is simultaneously transmitted to the sensors 2.

A plurality of time slots are allocated within this fixed amount of time. The number of time slots that are allocated within this fixed amount of time is N1. N1 is set so as to correspond to a maximum number of sensors 2 that can be connected to the ECU 1.

When the number of sensors 2 used for transmitting data that is collected by the ECU 1 is N2, when N2<N1, the sensors 2 transmit the data to the ECU 1 using a plurality of time slots. Here, a case in which N2<N1 because the number of sensors 2 connected to the ECU 1 is less than N1 is described. For example, the number of sensors 2 becomes less than N1 as a result of the number of sensors 2 changing due to variations in the vehicle.

As shown in FIG. 1, the ECU 1 according to the present embodiment is configured such that seven sensors 2 can be connected thereto. In correspondence thereto, N1=7. Here, in FIG. 1, a rectangular broken line indicates that the sensor 2 is not arranged at a connection destination of the ECU 1, and the connection destination of the ECU 1 is in an empty state.

A reception identifier (ID) is set for each connection destination of the ECU 1. The reception ID is used for reception of the transmission wave command outputted from the ECU 1, a command and response mode (CRM), and the like. According to the present embodiment, ID1 to ID7 are set for the connection destinations of the ECU 1, in order from a left-hand side in FIG. 1.

Two sensors 2 are connected to the ECU 1. When the two sensors 2 are respectively a sensor 21 and a sensor 22, the sensor 21 and the sensor 22 are arranged so as to respectively use ID1 and ID6 as the reception IDs.

In addition, transmission IDs are set for the sensors 21 and 22. The transmission ID is used for communication in the PDCM. To prevent communication interference, the timing at which each sensor 2 is to transmit data is determined in advance in correspondence to the transmission ID. Here, to enable data transmission using ID1 to ID7 to be successively performed, time slots corresponding to the IDs are set.

The sensor 2 ordinarily uses a single transmission ID that corresponds to the reception ID that is set as an arrangement destination. However, the sensor 2 according to the present embodiment transmits data to the ECU 1 using a plurality of transmission IDs.

Specifically, as a result of software setting of the sensor 21 and the sensor 22 being updated, the sensor 21 is set to use ID1 to ID3 as the transmission IDs. The sensor 22 is set to use ID4 to ID6 as the transmission IDs.

As a result of the setting being performed in this manner, as shown in FIG. 2, when the ECU 1 transmits the data transmission command to each sensor 2, the sensor 22 performs transmission of data three times after the sensor 21 performs transmission of data three times. According to the present embodiment in which the sensor 2 is the ultrasonic sensor, after information on the distance to the object outside the vehicle detected by the sensor 21 is transmitted three times, the information on the distance to the object outside the vehicle detected by the sensor 22 is transmitted three times.

Here, in FIG. 2, as well as FIG. 3 and FIG. 5 to FIG. 8, described hereafter, a rectangle that is shaded by slanted lines indicates time during which the sensor 21 transmits data. A rectangle that is shaded by dots indicates time during which the senor 22 transmits data. In addition, a rectangular broken line indicates time during which data is not transmitted.

In a conventional sensor system, when N2<N1, idle time occurs from when the ECU 1 transmits the data transmission command until when the ECU 1 next transmits the data transmission command. For example, in a case in which the sensors 2 are arranged only at the connection destinations that use ID1 and ID6 as the reception IDs as according to the present embodiment, as shown in FIG. 3, only ID1 and ID6 are used as the transmission IDs. The time slots for ID2 to ID5 and ID7 become idle time during which data transmission is not performed.

In this regard, according to the present embodiment, as a result of the sensors 2 transmitting data using a plurality of time slots as shown in FIG. 2, idle time is reduced. Communication can be increased in speed. For example, according to the present embodiment in which the sensor 2 is the ultrasonic sensor, the transmission interval of the distance information is shortened. A timing at which an obstacle is detected can be made earlier. In addition, redundant design becomes possible and reliability can be improved.

Furthermore, because the length of each time slot is fixed, the ECU 1 is not required to be provided with a function for ascertaining the length of each time slot. Consequently, system configuration becoming complex can be suppressed. Communication efficiency can be improved by a simple configuration.

In addition, as a method for improving communication efficiency, a method in which the interval at which the ECU 1 transmits the data transmission command is shortened when idle time occurs can be considered. In this method, for example, as shown in FIG. 3, in a case in which the time slot that corresponds to ID7 is idle time, the interval of the data transmission command is shortened by an amount amounting to the time slot. However, the idle time amounting to the time slots that correspond to ID2 to ID5 is not canceled. Therefore, the effect of improving communication efficiency is small.

In this regard, as a result of the sensors 21 and 22 that are connected to the ECU 1 transmitting data using ID2 to ID 5 as according to the present embodiment, the idle time amounting to the time slots that correspond to ID2 to ID5 can be canceled. Communication efficiency can be significantly improved.

### Second Embodiment

A second embodiment will be described. According to the present embodiment, the number of sensors 2 is changed from that according to the first embodiment. Other configurations are similar to those according to the first embodiment. Therefore, only sections that differ from those according to the first embodiment will be described.

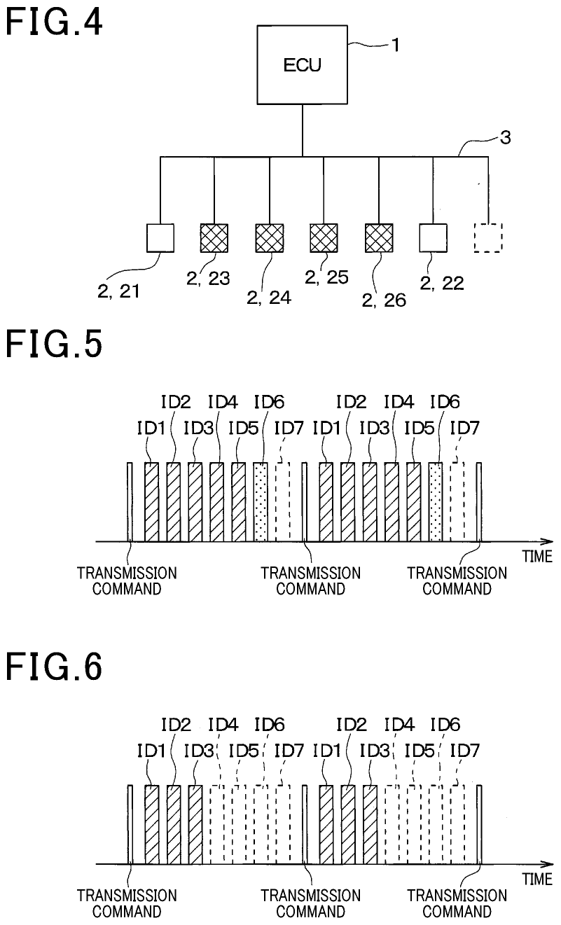

As shown in FIG. 4, according to the present embodiment, as the sensors 2, a sensor 23, a sensor 24, a sensor 25, and a sensor 26 are connected to the ECU 1, in addition to the sensor 21 and the sensor 22. Here, according to the present embodiment, among the plurality of sensors 2 that are connected to the ECU 1, only a part of the sensors 2 is used for transmitting data that is collected by the ECU 1. N2 is less than the number of sensors 2 that are connected to the ECU 1.

A shaded rectangle in FIG. 4 indicates the sensor 2 that is not used for transmitting data that is collected by the ECU 1. That is, only the sensors 21 and 22 are used for transmitting data that is collected by the ECU 1. The sensors 23 to 26 are not used for transmitting data that is collected by the ECU 1.

The reception IDs and the transmission IDs used by the sensor 21 and the sensor 22 are the same as those according to the first embodiment. The sensors 23 to 26 respective use ID2 to ID5 as the reception IDs and do not use the transmission ID.

In performing configuration such as this, when the ECU 1 transmits the data transmission command to the sensors 2, the sensors 23 to 26 do not perform data transmission. Only the sensors 21 and 22 perform data transmission in a manner similar to that according to the first embodiment.

For example, the sensors 2 that are operated may change based on a state of the vehicle and the number of sensors 2 used for transmitting data that is collected by the ECU 1 may decrease. In such cases, communication efficiency can be improved by data transmission from the sensor 2 that is not used for transmitting data that is collected by the ECU 1 being stopped as described above and a spare time slot being used by the sensor 2 that is used for transmitting data that is collected by the ECU 1.

### Other Embodiments

Here, the present disclosure is not limited to the above-described embodiments. Various modifications are possible. In addition, it goes without saying that an element that configures an embodiment according to the above-described embodiments is not necessarily a requisite unless particularly specified as being a requisite, clearly considered a requisite in principle, or the like. Furthermore, in cases in which a numeric value, such as quantity, numeric value, amount, or range, of a constituent element of an embodiment is stated according to the above-described embodiments, the numeric value is not limited to the specific number unless particularly specified as being a requisite, clearly limited to the specific number in principle, or the like.

For example, according to the above-described first embodiment, the number of time slots used by the sensor 21 and the number of time slots used by the sensor 22 are equal. However, the number of time slots that are used may differ with each sensor 2. In addition, according to the above-described first embodiment, each sensor 2 transmits data using a plurality of time slots. However, among the plurality of sensors 2, only a part of the sensors 2 may use a plurality of time slots. For example, as shown in FIG. 5, the sensor 21 may use ID1 to ID5 as the transmission IDs. The sensor 22 may use ID6 as the transmission ID.

In addition, data transmission by the sensor 22 may be ended before data transmission by the sensor 21. In cases in which a priority level of data transmission differs for each sensor 2, a plurality of consecutive time slots including an initial slot after the data transmission command are preferably used by the sensor 2 that has a high priority level.

In addition, according to the above-described first and second embodiments, the plurality of sensors 2 perform data transmission. However, the number of sensors 2 that are connected to the ECU 1 or the number of sensors 2 that are used for transmitting data that is collected by the ECU 1 may be one, and only a single sensor 2 may transmit data. For example, as shown in FIG. 6, the sensor 21 may use ID1 to ID3 as the transmission IDs, and the time slots corresponding to ID4 to ID7 may be idle time.

Furthermore, according to the above-described first embodiment, a same type of data is transmitted to the ECU 1 in each time slot. However, the software setting of the sensor 2 may be changed, and a differing type of data may be transmitted to the ECU 1 in each time slot. For example, when the sensor 21 uses ID1 as the transmission ID, the sensor 21 may transmit data on detected distance. When the sensor 21 uses ID2 as the transmission ID, the sensor 21 may transmit data on temperature. When the sensor 21 uses the ID3 as the transmission ID, the sensor 21 may transmit data on voltage that is supplied to the sensor 21.

In addition, the data that is transmitted to the ECU 1 from the sensor 2 may be data on physical quantity, such as distance, temperature, or voltage. Alternatively, the data may be data on information other than physical quantity, such as a determination flag, or an index value.

Furthermore, according to the first embodiment, the sensor 21 and the sensor 22 transmit the same type of data to the ECU 1. However, a differing type of data may be transmitted by each sensor 2.

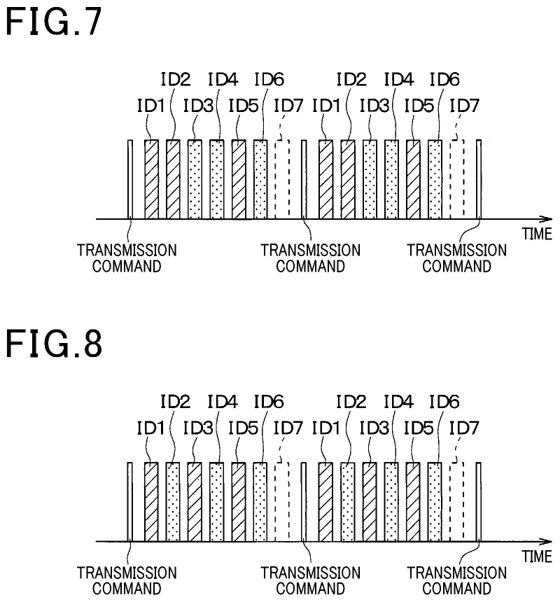

In addition, according to the first and second embodiments, the time slots that are used by each sensor 2 are consecutive. However, taking into consideration urgency level, priority level, and the like of the information to be transmitted, a time slot that is used by another sensor 2 may be arranged between two time slots that are used by one sensor 2. For example, as shown in FIG. 7, the sensor 21 may use ID1, ID2, and ID5 as the transmission IDs. The sensor 22 may use ID3, ID4, and ID6 as the transmission IDs. Furthermore, for example, as shown in FIG. 8, the sensor 21 may use ID1, ID3, and ID5 as the transmission IDs. The sensor 22 may use ID2, ID4, and ID6 as the transmission IDs.

Moreover, the present disclosure may be applied to a sensor system that includes a sensor other than the ultrasonic sensor.

What is claimed is:

1. A sensor system comprising:
at least one sensor; and
a control unit, the at least one sensor and the control unit communicating with each other using a time-division multiplexing method, wherein:
the control unit is capable of being connected to a plurality of sensors configuring the at least one sensor, and transmits a data transmission command to the at least one sensor connected to the control unit at every fixed amount of time; and
in response to a number of at least one target sensor, among the at least one sensor, for transmitting data collected by the control unit being less than a number of time slots allocated within the fixed amount of time, the at least one sensor transmits data to the control unit using a plurality of time slots using a plurality of transmission identifiers that predetermine a timing at which each of the plurality of sensors transmits data.

2. The sensor system according to claim 1, wherein:
a number of the at least one sensor connected to the control unit is less than the number of time slots allocated within the fixed amount of time.

3. The sensor system according to claim 1, wherein:
the control unit is connected to the plurality of sensors.

4. The sensor system according to claim 3, wherein:
the number of the at least one target sensor used for transmitting data collected by the control unit is less than the number of the plurality of sensors connected to the control unit.

5. The sensor system according to claim 3, wherein:
each of the plurality of sensors transmits data using a plurality of time slots.

6. The sensor system according to claim 3, wherein:
a part of the plurality of sensors transmits data using a plurality of time slots.

7. The sensor system according to claim 3, wherein:
the plurality of sensors use equal numbers of time slots.

8. The sensor system according to claim 3, wherein
the plurality of sensors use different numbers of time slots.

9. The sensor system according to claim 3, wherein:
a single sensor of the plurality of sensors uses a plurality of consecutive time slots.

10. The sensor system according to claim 3, wherein:
the plurality of sensors includes a first sensor and a second sensor; and
a time slot used by the first sensor is arranged between two time slots used by the second sensor.

11. The sensor system according to claim 3, wherein:
the plurality of sensors transmit a same type of data.

12. The sensor system according to claim 3, wherein:
the plurality of sensors transmit differing types of data.

13. The sensor system according to claim 1, wherein:
the at least one sensor transmits a same type of data in each respective time slot.

14. The sensor system according to claim 1, wherein:
the at least one sensor transmits differing types of data in each respective time slot.

15. The sensor system according to claim 1, wherein:
the at least one sensor comprises an ultrasonic sensor.

16. The sensor system according to claim 1, wherein:
the control unit and the at least one sensor are connected by wired connection.
